(19) United States
(12) Patent Application Publication
(10) Pub. No.: US 2001/0018389 A1
(43) Pub. Date: Aug. 30, 2001

(54) APPARATUS AND METHOD FOR AUTOMATICALLY GENERATING A CAM CYCLE REPRESENTING CONTROL SIGNALS USED TO EXECUTE A CAM PROFILE REPRESENTING MOYION OF A HOOK FOR FOLDING A BACK FLAP OF A CARTON

(76) Inventors: MICHAEL D. WALLACE, MOORINGSPORT, LA (US); RONALD J. MONTGOMERY, KEITHVILLE, LA (US)

Correspondence Address: LANCE VIETZKE, DORSEY & WHITNEY LLP, PILLSBURY CENTER SOUTH, 220 SOUTH SIXTH STREET, MINNEAPOLIS, MN, 55402

(21) Appl. No.: 09/295,547

(22) Filed: Apr. 21, 1999

(51) Int. Cl. B31B 1/00

(52) U.S. Cl. 493/24

(57) ABSTRACT

An apparatus and method for folding a back flap of a carton. The apparatus stores parameters relating to a backfold process, and receives a value representing the length of the back flap to be folded. Based upon the parameters and the value representing the length of the back flap, the apparatus determines when to begin moving the hook for folding the back flap and when to stop moving the hook.

### TECHNICAL FIELD

The present invention relates to an apparatus and method for folding a back flap on a moving carton or other article.

### BACKGROUND

Folding of cartons from cardboard blanks requires certain apparatus within a carton folding machine. One of the more challenging aspects in the folding process involves folding the back flap. Folding of the back flap can be more difficult than folding of other flaps because the back flap is moving in the direction required for folding. Therefore, the folding requires precise timing in order to move and position a hook for the folding of the back flap as it passes through the machine. In order to fold the back flap, the machine typically requires input of several parameters or variables in order to calculate when to move the hook in order to strike the back flap at a location required for folding. Use of several potentially changing variables may complicate the process and limit the speed at which the back flaps may be folded and hence rate at which cartons pass through the machine.

Accordingly, a need exists for an improved apparatus for folding a back flap of a carton or other article.

### SUMMARY

Methods consistent with the present invention determine when to trigger a hook for folding a back flap of a moving carton such that the hook strikes the back flap at a strike point for folding.

A first method includes receiving at least one value representing at least one parameter relating to determining when to trigger the hook, at least one of the values being related to a length of the back flap. It also includes determining, based upon the at least one value, when to trigger the hook such that the hook strikes the back flap at the strike point, and storing the at least one value for use in triggering the hook to fold the back flap.

A second method includes detecting an edge of a back flap of a moving carton. Based upon the detecting and a value related to a length of the back flap, a first signal is provided for initiating rotation of the hook to strike the back flap at the strike point for folding the back flap. A second signal is provided to stop rotation of the hook upon completion of the folding of the back flap.

A third method includes generating a cam cycle, representing a pattern of rotation of the hook, based at least in part upon a value related to a length of a back flap to be folded. The cam cycle is initiated based upon an event related to detection of the back flap, and the cam cycle is stopped based upon receiving an indication of a particular rotational position of the hook.

An apparatus consistent with the present invention determines when to trigger a hook for folding a back flap of a moving carton such that the hook strikes the back flap at a strike point for folding. The apparatus includes an input connection for use in receiving values representing parameters relating to determining when to trigger the hook, at least one of the values being related a length of the back flap. A controller, coupled to the input connection and an output connection, determines, based upon the values, when to trigger the hook such that the hook strikes the back flap at the strike point, and it provides at the output connection a signal to a motor controlling the hook in order to trigger the hook.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of a system for folding a back flap of a carton or other article;

FIG. 2 is a diagram of a carton folding machine, including a backfold apparatus;

FIG. 3A is a diagram of the backfold apparatus within the carton folding machine shown in FIG. 2;

FIG. 3B is an exploded diagram of the backfold apparatus shown in FIG. 3A;

FIG. 4A is a diagram illustrating a backfold process;

FIG. 4B is a diagram illustrating a cam profile for a backfold process;

FIGS. 5A-5C are flow charts illustrating operation of a backfold process; and

FIG. 5D is a flow chart of a process for generating a cam cycle.

### DETAILED DESCRIPTION

Embodiments consistent with the present invention determine when to trigger a hook for folding a back flap of a carton or other article as it moves through a carton folding machine. The hook strikes the back flap at a strike point so that rotation of the hook folds over the back flap as the carton moves through the machine. Such embodiments use a value related to a length of a back flap to automatically generate signals or other information for controlling a motor to trigger the hook. Several methods may implement the determination of when to trigger the hook based upon the value related to the length of the back flap.

For example, a first method includes receiving values representing parameters relating to determining when to trigger the hook with at least one of the values being related to a length of the back flap. The first method also includes determining, based upon the values, when to trigger the hook such that the hook strikes the back flap at the strike point and storing the values for use in triggering the hook to fold the back flap. An exemplary second method includes detecting an edge of a back flap of a moving carton. Based upon the detecting and a value related to a length of the back flap, the second method includes providing a first signal for initiating rotation of the hook to strike the back flap at the strike point for folding the back flap and providing a second signal to stop rotation of the hook upon completion of the folding. An exemplary third method includes generating a cam cycle, representing a pattern of rotation of the hook, based at least in part upon a value related to a length of a back flap to be folded. The third method includes initiating the cam cycle based upon an event related to detection of the back flap and stopping the cam cycle based upon receiving an indication of a particular rotational position of the hook.

In addition, an apparatus may implement embodiments consistent with the present invention to use a value related to a length of a back flap for folding it. An exemplary apparatus includes an input connection for use in receiving values representing parameters relating to determining when to trigger the hook with at least one of the values being related a length of the back flap. A controller, coupled to the input connection and an output connection, determines, based upon the values, when to trigger the hook such that the hook strikes the back flap at the strike point, and it provides at the output connection a signal to a motor controlling the hook in order to trigger the hook.

### Backfold Apparatus

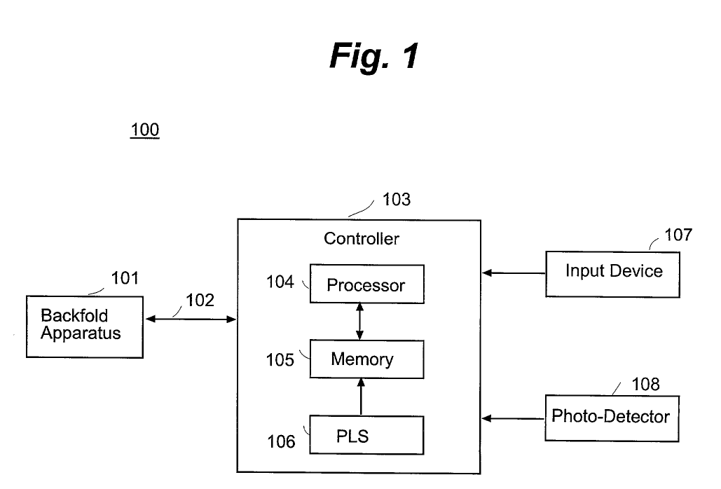

FIG. 1 is a diagram illustrating a backfold system 100. System 100 includes a backfold apparatus 101 electronically connected to a controller 103 via connection 102. Controller 103 includes one or more input connections for receiving information from an input device 107 and/or a photodetector 108 for use in executing a backfold process. Controller 103 also includes an output connection for sending signals to backfold apparatus 101. Backfold apparatus 101 includes electric motors and mechanical structure for folding a back flap of a carton. The term carton refers to any article having a section, referred to as a back flap, to be folded; examples include, but are not limited to, unassembled or partially assembled boxes or other containers, composed of cardboard, paper, or any material capable of being folded.

Controller 103 includes a processor 104 electronically connected with a memory 105 for storing data and programs to be executed by processor 104. Controller 103 also includes a programmable limit switch (“PLS”) 106 electronically connected with memory 105. PLS's are known in the art and are used for controlling rotational movement of a shaft or motor by providing feedback information concerning a rotational position of the shaft or linear position of other mechanical structure.

Input device 107 may be used by a user or other person, for example, to enter values for particular parameters into controller 103, if processor 104 may require those values in calculating signals to control backfold apparatus 101. Input device 107 may be implemented with any type of peripheral device for entering information into a computer or computer-controlled device either through a wireline or wireless connection, and examples of input devices include a keyboard, keypad, touch-screen display device, switches, or a data connection device.

Controllers used for controlling motors are known in the art. An example of a controller, which includes a PLS, is the Indramat DDS drive used with the Indramat CLC card. For that exemplary controller, the CLC card implements input device 107 to receive information used to generate a cam profile for controlling motion of a backfold hook. The DDS drive implements controller 103 by remotely receiving the cam profile from the CLC card via fiber optic cable and by generating the corresponding cam cycle to control operation of the motor and thus rotation of the hook. An advantage of this exemplary implementation is that one CLC card may provide cam profiles to multiple DDS drives located distance from the CLC card. Alternatively, other types of controllers or processor-controlled devices may be used to control motion of the hook, and the input device may be part of the controller. Other examples of controllers include the 1394 servo-controller by Allen-Bradley Co. and the SC9000 drive by Pacific Scientific. Embodiments consistent with the present invention, however, may be implemented with any processor-controlled servo-controller.

Photodetector 108, electronically coupled to controller 103, provides a signal for detecting an edge of a carton for use in determining when to fold a back flap of the carton. Examples of a photodetector include any photoeye, such as the Allen-Bradley Co. photoeye. Alternatively, system 100 may use other devices for detecting an edge of a carton such as other devices using light signals to detect the edge, or devices using mechanical components for detecting the edge.

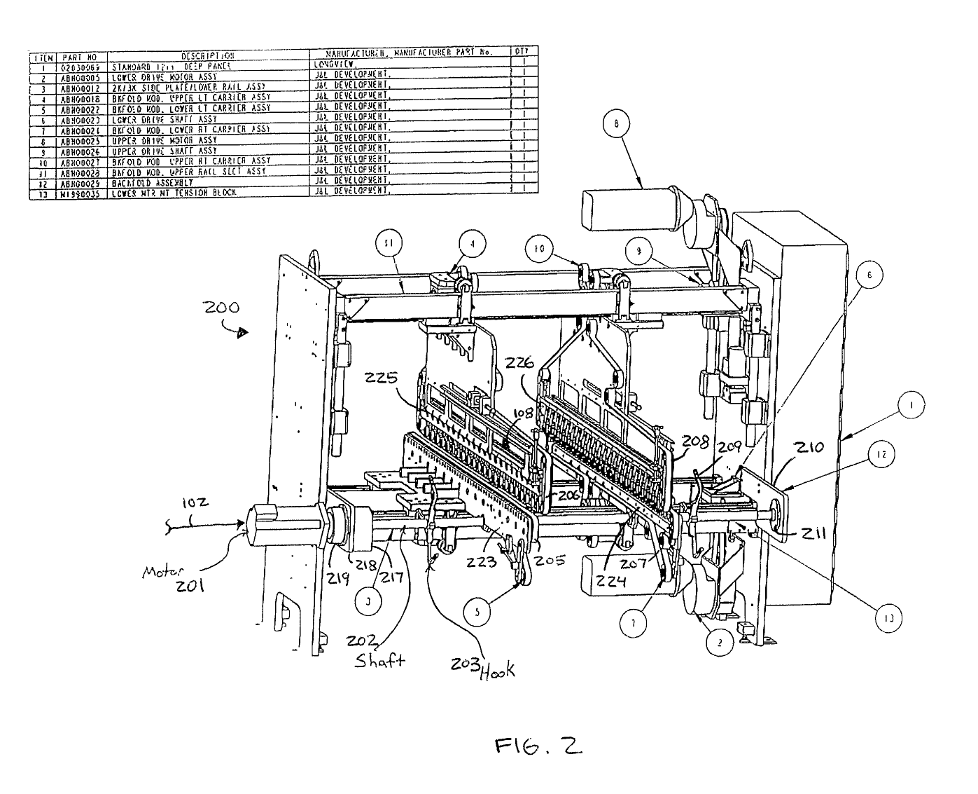

FIG. 2 is a diagram of a carton folding machine 200, which includes structure for moving a carton through the machine and backfold apparatus 101. Machine 200 includes cooperating belts 205 and 206, and belts 207 and 208, typically situated on top of one another but shown apart in the diagram for illustrative purposes only. Belts 205 and 207 are mounted on, respectively, lower carrier assemblies 223 and 224, and belts 206 and 208 are mounted on, respectively, upper carrier assemblies 225 and 226. Machine 200 includes motors associated with the carrier assemblies 223-226 for driving belts 205-208. A carton moving through machine 200 is sandwiched between belts 205 and 206, and between belts 207 and 208, for transport through machine 200.

Photodetector 108 is mounted within machine 200 for detecting an edge of a back flap as a carton passes through machine 200. Backfold apparatus 101 within machine 200 includes a motor 201 for driving a shaft 202, which includes hooks 203 and 209 mounted on it. The term hook refers any mechanical structure for use in folding a back flap of a carton. Although this example uses L-shaped hooks engaging in rotational motion, a hook may have a different shape or configuration and may engage in any type of rotational or other movement. Motor 201 via shaft 202 rotates hooks 203 and 209 for folding a back flap of a carton as it passes through machine 200. Therefore, associated with machine 200 is controller 103 for providing signals to motor 201 via connection 102 for rotating hooks 203 and 209. An example of a carton folding machine is disclosed in U.S. Pat. No. 5,151,075, which is incorporated herein by reference as if fully set forth. Embodiments consistent with the present invention may be used with any type of carton folding machine for automatically folding cartons as they move through the machine.

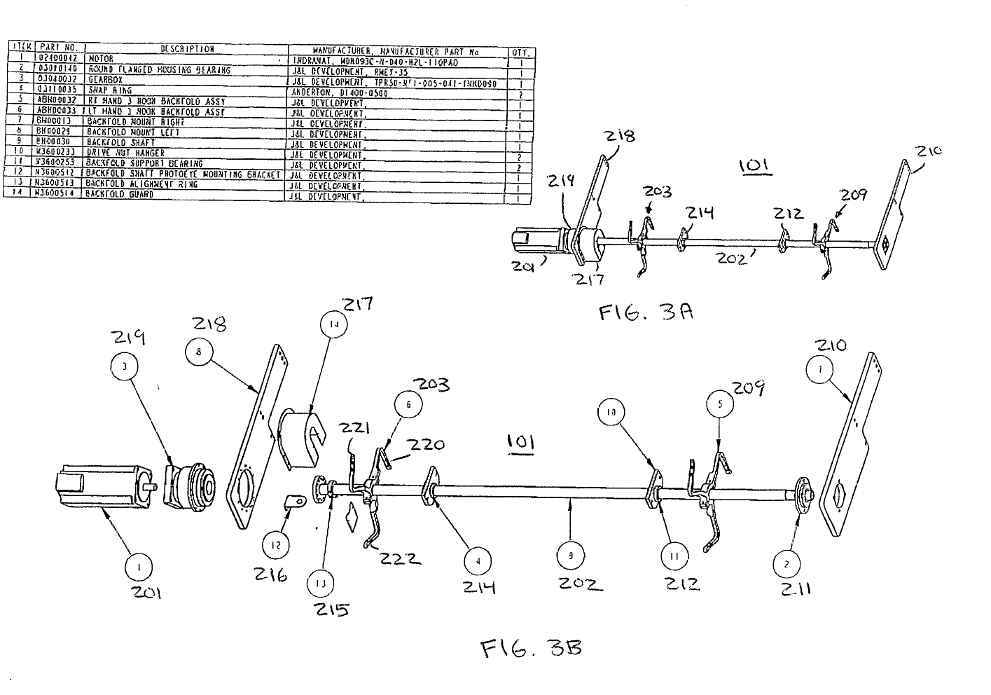

FIG. 3A is a diagram of backfold apparatus 101 in machine 200, and FIG. 3B is an exploded diagram of backfold apparatus 101. Backfold apparatus 101 includes motor 201 connected to a gear carton 219. Gear carton 219 is mounted within a bracket 218, and a backfold guard 217 houses a backfold alignment ring 215 attached to shaft 202. Mounted on shaft 202 is hook 203 including three hook fingers 220, 221 and 222 spaced substantially equally apart. The term hook finger refers to any type of structure on a hook for use in folding a back flap of a carton. Also mounted on shaft 202 is another three-finger hook 209. Shaft 202 includes a first snap ring 212 and a second snap ring 214 for mounting, respectively, on lower carrier assemblies 224 and 223 shown in FIG. 2. Shaft 202 also includes a bearing 211 mounted within a backfold bracket 210 for allowing rotation of shaft 202. A photoeye mounting bracket 216 attaches photodetector 108 to carton folding machine 200 so that it faces downward toward cartons in order to detect edges of back flaps of the cartons moving through machine 200.

### Backfold Process

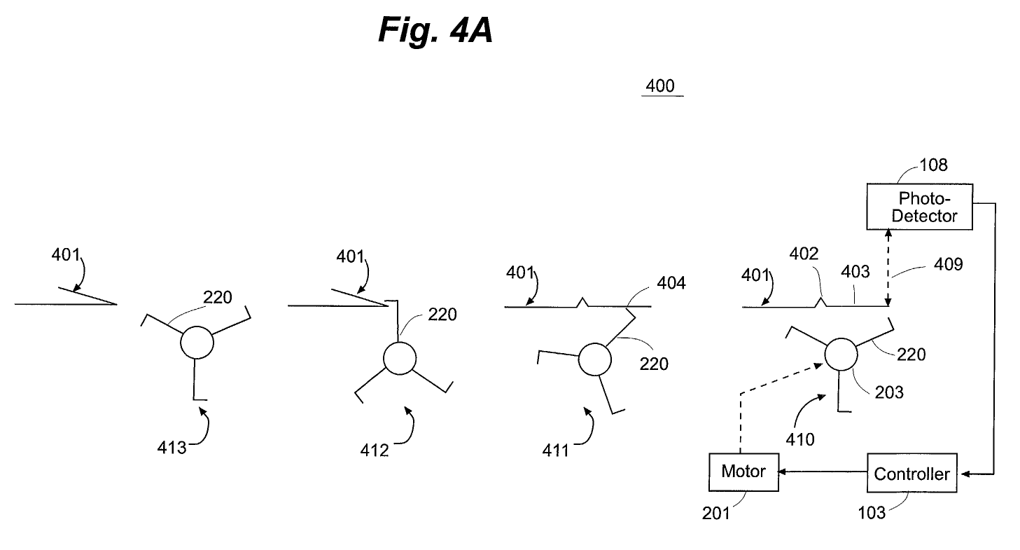

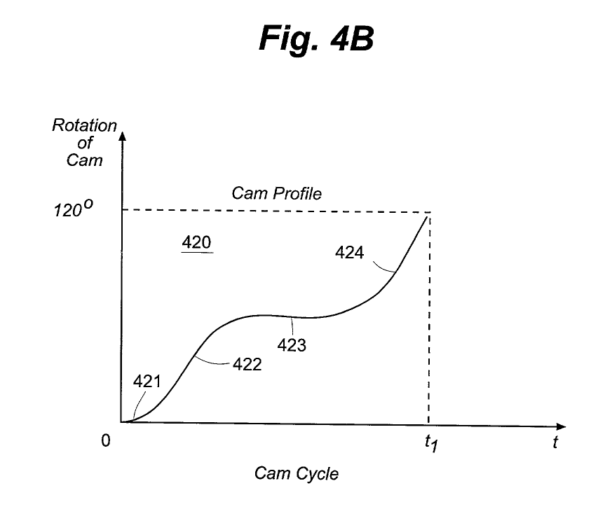

FIG. 4A is a diagram illustrating a backfold process using backfold apparatus 101 and controller 103 with associated photodetector 108. A backfold process includes any process or method for folding a back flap of a carton. In this exemplary process 400, a carton 401 moves from right to left through backfold apparatus 101. Carton 401 includes a back flap 403 and a scoreline 402 at which the flap is to be folded. The folding occurs using hook 203 including one of its hook fingers 220. In order to correctly fold back flap 403, hook finger 220 should strike back flap 403 at a strike point 404. The term strike point refers to an area on the back flap used for folding it when contacted by a hook; a strike point may include an area, and not only a single point, so that it permits a margin of error for the hook to contact and fold the back flap. When photodetector 108, using infrared lightbeam 409, detects the edge of back flap 403, it sends a corresponding signal to controller 103 so that processor 104 may calculate when to signal motor 201 in order to trigger hook 203, meaning to initiate a process for folding a back flap of a carton.

In position 410, hook 203 is in a start position. Upon detecting the edge of back flap 403 via photodetector 108, controller 103 initiates backfold process 400. Controller 103 signals motor 201 to begin rotating hook 203 so that hook finger 220 strikes back flap 403 at strike point 404. Depending upon a speed of carton 401 and rotational speed of hook 203, controller 103 may wait to signal motor 201 to begin rotating hook 203, referred to as a dwell period. The dwell period may be used to ensure that hook finger 220 correctly contacts back flap 403 at strike point 404. Position 411 illustrates rotation of hook 203 with hook finger 220 contacting back flap 403 at strike point 404 to begin folding back flap 403 about score line 402. As carton 401 continues to move through the apparatus, motor 201 continues to rotate hook 203 to fold back flap 403, using hook finger 220, during movement of carton 401 until back flap 403 is folded over, as shown in position 412.

At position 412, controller 103 may signal motor 201 to stop rotation and dwell hook 203. A dwell period is used in position 412 to allow carton 401 to move clear of hook 203. Otherwise, if hook 203 continued to rotate after folding of the back flap 403, as shown in position 412, hook finger 220 may puncture or damage back flap 403. After carton 401 moves clear of hook 203, controller 103 signals motor 201 to again rotate hook 203 to rotate down hook finger 220 to an ending position, as shown in position 413, which completes backfold process 400. Upon completion of process 400, hook 203 is ready to receive the next carton for folding.

As shown in this example, hook 203 is a three-finger hook where each hook finger is separated by 120°. The three-finger hook allows for faster folding, and hence folding of more cartons in a given time period, as compared to a two-finger hook. Although a three-finger hook is shown in this example, embodiments consistent with the present invention may use a hook having more or fewer hook fingers.

FIG. 4B is a diagram illustrating a cam profile 420 for backfold process 400. Cam profile 420 represents a pattern of rotation of hook 203 during process 400, and the execution of such rotation is referred to as a cam cycle. Cam profile 420 is only one example of particular motion or pattern of rotation of a hook for folding a back flap of a carton; cam profiles include any motion of a hook, and corresponding cam cycles to execute the motion, for folding a back flap of a carton. Since this example uses a three-finger hook, hook 203 rotates 120°, as shown on the y-axis, during a time t₁, as shown on the x-axis. A portion 421 of the cam cycle represents an optional initial dwell period of hook 203 where rotation is delayed following detection of an edge of a back flap to be folded. A portion 422 represents rotation of hook 203 to fold the back flap, as indicated by rotation after the dwell period from position 411 to position 412 when the back flap is folded over. A portion 423 represents another dwell period to stop rotation of hook 203 so that the back flap may move clear of the hook to avoid damaging the back flap. A portion 424 represents final rotation of hook 203 to rotate hook finger 220 down to ending position 413, completing 120° of rotation for the cam cycle.

An implementation of controller 103 may automatically generate the cam cycle from a particular cam profile using empirical evidence. For example, a user may manually position the hook at various angular rotations and enters those points into the controller. Using the entered points representing a cam profile, controller 103 generates a cam cycle necessary to control the motor to rotate the hook so that motion of the hook corresponds to the cam profile.

### Execution of Backfold Process

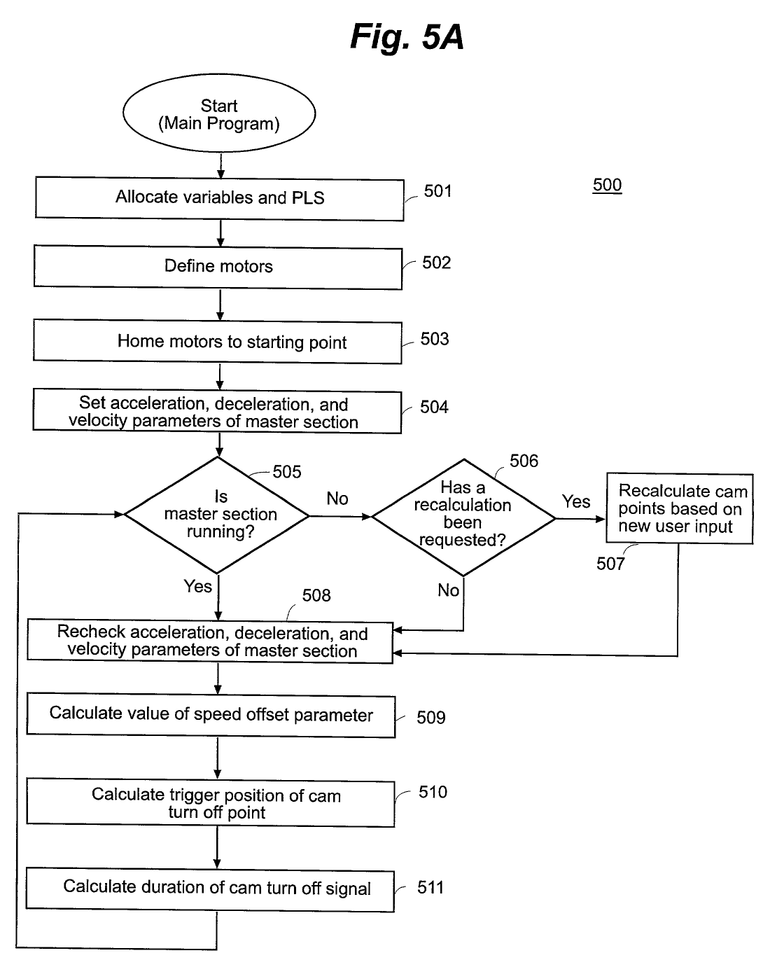

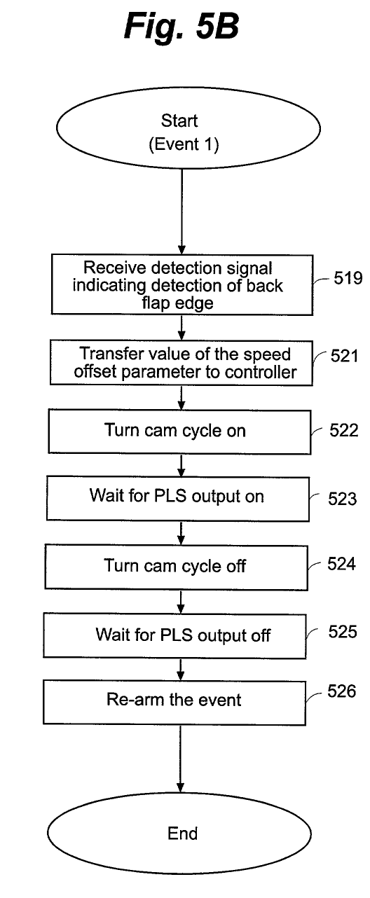

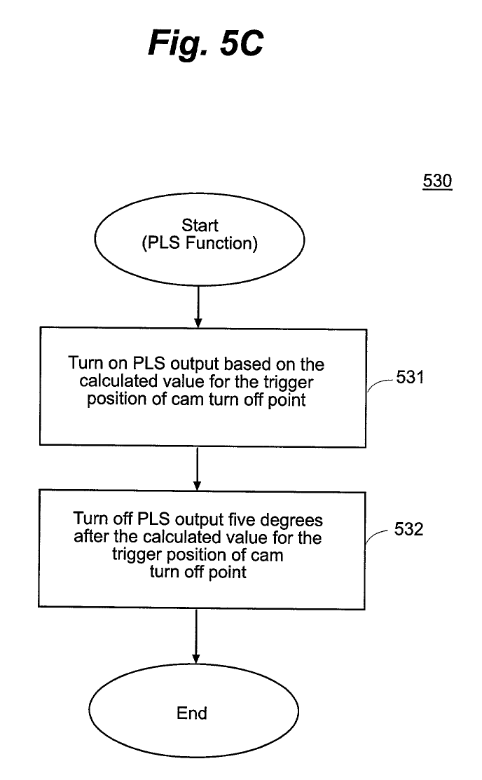

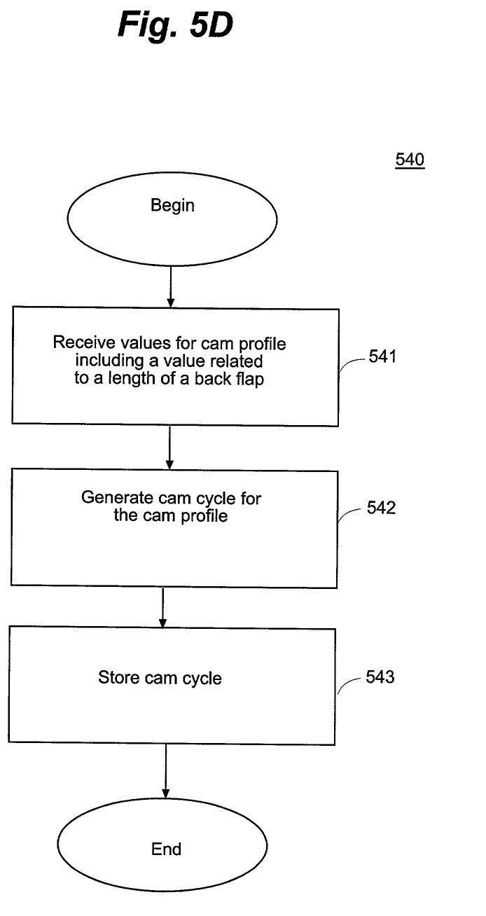

FIGS. 5A-5C are flow charts of programs for controlling processor 104 to execute a backfold process, such as process 400. These programs or portions of them may be implemented by processor 104 accessing a program in memory 105, for example, to implement the functions of the flow charts. Each of the flow charts illustrates these functions in a series of blocks. Therefore, a backfold process may be implemented by software modules stored in memory 105 or received from another source, or alternatively by hardware modules or a combination of software and hardware modules. In addition, the program or other information for executing the process may also be stored on or read from other types of computer program products or computer-readable media, such as secondary storage devices, including hard disks, floppy disks, or CD-ROM; a signal from a network; or other forms of RAM or ROM. The computer-readable media may include instructions for controlling a computer system, such as processor 104, to perform a particular method such as that shown in FIGS. 5A-5D.

Memory 105 may also store information concerning various parameters or variables for use in a backfold process. For example, it may use one or more of the following stored variables: a strike point on the back flap, a speed of the hook relative to a speed of the carton, and a position of the back flap relative to the hook. It may also use a parameter indicating or related to a length of a back flap to be folded, as received from a user or other source via input device 107. It may use a value representing the actual length of a back flap to be folded or use a value related to the length. For example, it may receive or use a value representing a fraction of the length and, if necessary, process that value to determine the length or otherwise determine a strike point.

An exemplary backfold process includes three software programs for execution by the system, implemented by processor 104 operating under software or firmware control: a main program 500 (FIG. 5A), an event1 program 520 (FIG. 5B), and a PLS function program 530 (FIG. 5C). Each of the three programs in this example operate simultaneously and concurrently in the system. FIG. 5A is a flow chart of main program 500. In this program, the system allocates variables and PLS 106 (block 501), which represents an initialization act to identify an amount of memory required. The system also defines the motors in backfold apparatus 101 (block 502), representing another initialization act to identify the motors for the system. The system sets each motor 201 to a home position, and any other motors used for the backfold process, to a starting point (block 504), which is an initialization act to ensure that the hooks are in the correct starting position, as they may initially be out of position when power is first applied to the system. The system also sets acceleration, deceleration, and velocity parameters of the master section and stores values of the parameters in memory (block 504). The values of these parameters are obtained from the master section and are used as a reference for controlling hook 203. The master section refers to carton folding machine 200 or any machine using backfold apparatus 101, and the master section provides a reference signal, from the values of acceleration, deceleration, and velocity parameters, for use by the system in controlling backfold apparatus 101.

The system determines if the master section is running (block 505). If the master section is running, the system rechecks the values of the acceleration, deceleration, and velocity parameters of the master section (block 508). The system rechecks those values every time main program 500 executes the loop in the event they would have been changed by, for example, a user changing values of operating parameters for the master section.

Otherwise, if the master section is not running, indicating that carton folding machine 200 is not operating, backfold apparatus 101 likewise should not operate. Therefore, the system determines if a recalculation has been requested by a user (block 506), which may occur through input device 107. If a recalculation has been requested, the system recalculates the cam points to generate a new cam cycle based upon the new user-entered values (block 507) and then rechecks acceleration, deceleration, and velocity parameters of the master system (block 508). The cam points represent information used to generate the cam cycle and known controllers typically provide functions to automatically generate a cam cycle for a particular cam profile based on user-entered information such as manually positioning of the hook and entering those points. Once this determination is made, a user need only enter the length of the back flap to perform the folding of the back flap.

After rechecking the values of the parameters, the system performs calculations for controlling motor 201 to rotate hook 203 according to a particular cam cycle. In particular, the system calculates a speed offset parameter (block 509), which represents a variable used to implement the initial dwell period as shown by portion 421 in cam profile 420. Since the cam cycle is used for rotational movement, the speed offset parameter represents an angular phase advance to advance rotation of the hook following turning on of the cam cycle. In this particular example, the speed offset is generated from the equation: 0.04 times the speed of the master section. The system calculates the trigger position of the cam turn off point (block 510), which represents a rotational position of hook 203 at which to turn on the output of PLS 106 and stop rotation of hook 203. The system thus uses the PLS output signal to stop rotation of the hook and complete the cam cycle. The system also calculates the duration of the cam turn off signal (block 511), which indicates when to turn off the PLS output signal after stopping rotation of hook 203.

The system loops back to block 505 for the next cycle. Main program 500 in the system scans inputs at a particular rate, possibly different than the rate of the other programs, for performing the calculations and recalculations. Event1 520 and PLS function 530 programs use the information calculated by main program 500.

FIG. 5B is a flow chart of event1 program 520. In this program, the system receives a detection signal from photodetector 108 indicating detection of an edge of a back flap to be folded (block 519). In response to the detection signal, the system transfers a value of the speed offset parameter, as calculated in block 508, to controller 103 (block 521). Controller 103 uses the speed offset parameter, which provides for an advance if necessary, to determine when to signal motor 201 to start rotation of hook 203 based upon its previously generated cam cycle stored in memory 106. The system turns the cam cycle on (block 522), which initiates the cam cycle for execution of a cam profile, typically beginning with delay in portion 421 as determined using the speed offset parameter. The system waits for a PLS output on signal from PLS 106 (block 523).

PLS 106 monitors a position of the master section. When PLS 106 detects that the carton having the back flap being folded traveled a particular distance, PLS 106 sets a bit in memory 105. The position at which PLS 106 provides the PLS output on signal is generally predetermined for a particular cam profile. Upon detecting the set bit in memory 105 indicating the PLS output on signal, the system turns the cam cycle off (block 524) to stop the cam cycle, signaling motor 201 to stop rotation of hook 203 and completing the 120° rotation of the cam cycle. The system monitors the bit used by PLS 106 to detect a PLS output off signal (block 525). After PLS 106 resets the bit, indicating the PLS output off signal, the system re-arms the event (block 526), meaning that the system waits for another signal from photodetector 108 as detected by the act shown in block 519, indicating detection of an edge of another back flap, to repeat the event for folding of another back flap.

FIG. 5C is a flow chart of PLS function program 530, which controls operation of PLS 106 for use with event1 1program 520. In PLS function program 530, the system turns on the PLS output (block 531), setting the bit in memory 105, based on the calculated value for the trigger position as determined by the act shown in block 509. PLS 106 uses the trigger position to indicate, via the setting of the bit in memory 105, a particular position of the master section corresponding to an ending position of hook 203 upon completion of the cam cycle, shown in position 413. Event1 program 520 uses that indication to determine when to stop rotation of hook 203 using motor 201. When master section moves the carton being folded a linear distance corresponding to five degrees after the position determined by the value of the trigger position of the cam turn off point determined by the act shown in block 510, PLS 106 resets the bit in memory 105, providing the PLS output off signal (block 532) used by event1 program 520 in block 525. The value of the cam turn off signal calculated in block 511 provides the translation between a linear distance through the master section corresponding to five degrees of rotational movement of hook 203. The calculation in block 511 may use an equation to dynamically change the value if the value of the trigger position of the cam turn off point changes.

FIG. 5D is a flow chart of a process 540 for generating a cam cycle used by event1 program 520. In process 540, controller 103 receives values of parameters used for a particular cam profile including a value related to a length of a back flap to be folded (block 541). It may receive at least some of those values through empirical evidence. For example, a user may position the hook at various angular rotations and enter those points into controller 103. Such points may include the starting point shown in position 410, the ending point shown in position 413, and at least one point in between such as points defining dwell periods 421 and 423. Also, one of those points may provide positional information relating to the length of the back flap. Once this determination is made and the cam profile is generated, a user need only enter a length of a back flap to perform the folding process.

Upon receiving the values, controller 103 generates a cam cycle for that cam profile (block 542). Implementations of controller 103, such as the Intramat DDS drive used with the Indramat CLC card, automatically generate a cam cycle necessary to control the motor to rotate the hook so that motion of the hook corresponds to the cam profile. In conjunction with automatically generating the cam cycle, controller 103 stores information in memory 105 for executing the cam cycle (block 543) such as a sequence of signals for controlling operation of a motor to rotate a hook, and implementations of controller 103 typically automatically generate such signals corresponding to entered points for a cam profile.

While the present invention has been described in connection with an exemplary embodiment, it will be understood that many modifications will be readily apparent to those skilled in the art, and this application is intended to cover any adaptations or variations thereof. For example, different carton folding machines, controllers, PLS's, input devices, and photodetectors may be used without departing from the scope of the invention. This invention should be limited only by the claims and equivalents thereof.

What is claimed is:

1. A method of determining when to trigger a hook for folding a back flap of a moving carton such that the hook strikes the back flap at a strike point for folding, comprising:
receiving at least one value representing at least one parameter relating to determining when to trigger the hook, the at least one value being related to a length of the back flap;
determining, based upon the at least one value, when to trigger the hook such that the hook strikes the back flap at the strike point; and
storing the at least one value for use in triggering the hook to fold the back flap.

2. The method of claim 1, further including providing, based upon the determining, a signal to a motor controlling the hook in order to trigger the hook.

3. The method of claim 1, wherein the receiving includes receiving values of acceleration, deceleration, and velocity parameters for the motor.

4. The method of claim 1, wherein the determining includes calculating values of a speed offset parameter, a trigger position of a cam turn off point, and a duration of a cam turn off signal.

5. The method of claim 4, wherein the calculating includes recalculating the cam points based upon user-entered information.

6. The method of claim 1, wherein the providing includes turning a cam cycle on.

7. The method of claim 6, wherein the providing includes turning the cam cycle off.

8. The method of claim 1, wherein the receiving includes receiving a detection signal indicating detection of an edge of the back flap.

9. The method of claim 8, wherein the receiving includes receiving the detection signal from a photodetector.

10. The method of claim 1, wherein the providing includes providing the signal to trigger a rotation of approximately 120°.

11. A method of determining when to trigger a hook for folding a back flap of a moving carton such that the hook strikes the back flap at a strike point for folding, comprising:
detecting an edge of a back flap of a moving carton;
providing, based upon the detecting and a value related to a length of the back flap, a first signal for initiating rotation of the hook to strike the back flap at the strike point for folding the back flap; and
providing a second signal to stop rotation of the hook upon completion of the folding of the back flap.

12. A method of determining when to trigger a hook for folding a back flap of a moving carton such that the hook strikes the back flap at a strike point for folding, comprising:
generating a cam cycle, representing a pattern of rotation of the hook, based at least in part upon a value related to a length of a back flap to be folded;
initiating the cam cycle based upon an event related to detection of the back flap; and
stopping the cam cycle based upon receiving an indication of a particular rotational position of the hook.

13. The method of claim 12, wherein the initiating includes providing a signal to advance rotation of the hook based upon a particular speed offset value.

14. The method of claim 12, wherein the stopping includes receiving a signal from a programmable limit switch providing the indication of the particular rotational position.

15. The method of claim 12, wherein the stopping includes providing a signal to stop rotation of the hook after the hook has rotated approximately 120°.

16. An apparatus for determining when to trigger a hook for folding a back flap of a moving carton such that the hook strikes the back flap at a strike point for folding, comprising:
an input connection for use in receiving values representing parameters relating to determining when to trigger the hook, at least one of the values being related a length of the back flap;
an output connection; and
a controller, coupled to the input connection and the output connection, for determining, based upon the values, when to trigger the hook such that the hook strikes the back flap at the strike point and for providing at the output connection a signal to a motor controlling the hook in order to trigger the hook.

17. The apparatus of claim 16, further including:
a motor electrically coupled to the output connection; and
a hook rotatably coupled to the motor.

18. The apparatus of claim 17, wherein the hook comprises a three-finger hook.

19. The apparatus of claim 16, further including a photodetector coupled to the input connection.

20. The apparatus of claim 16, wherein the controller includes:
a processor; and
a programmable limit switch, coupled to the processor, for use in controlling the motor.

21. The apparatus of claim 16, further including an input device, electronically coupled to the input connection, for use in entering the values.

22. A computer program product, comprising:
a computer-readable medium containing instructions for controlling a computer system to perform a method of determining when to trigger a hook for folding a back flap of a moving carton such that the hook strikes the back flap at a strike point for folding, the method including:
receiving at least one value representing at least one parameter relating to determining when to trigger the hook, the at least one value being related to a length of the back flap;
determining, based upon the at least one value, when to trigger the hook such that the hook strikes the back flap at the strike point; and
storing the at least one value for use in triggering the hook to fold the back flap.

23. The computer program product of claim 22, further including providing, based upon the determining, a signal to a motor controlling the hook in order to trigger the hook.

24. The computer program product of claim 23, wherein the receiving includes receiving values of acceleration, deceleration, and velocity parameters for the motor.

25. The computer program product of claim 22, wherein the determining includes calculating values of a speed offset parameter, a trigger position of a cam turn off point, and a duration of a cam turn off signal.

26. The computer program product of claim 22, wherein the calculating includes recalculating the cam points based upon user-entered information.

27. The computer program product of claim 22, wherein the providing includes turning a cam cycle on.

28. The computer program product of claim 27, wherein the providing includes turning the cam cycle off.

29. The computer program product of claim 22, wherein the receiving includes receiving a detection signal indicating detection of an edge of the back flap.

30. The computer program product of claim 29, wherein the receiving includes receiving the detection signal from a photodetector.

31. The computer program product of claim 22, wherein the providing includes providing the signal to trigger a rotation of approximately 120°.

32. A system determining when to trigger a hook for folding a back flap of a moving carton such that the hook strikes the back flap at a strike point for folding, comprising:
a carton folding machine for automatically folding cartons as the cartons move through the machine; and
a backfold apparatus associated with the carton folding machine, the backfold apparatus including:
an input connection for use in receiving values representing parameters relating to determining when to trigger the hook, at least one of the values being related a length of the back flap;
an output connection; and
a controller, coupled to the input connection and the output connection, for determining, based upon the values, when to trigger the hook such that the hook strikes the back flap at the strike point and for providing at the output connection a signal to a motor controlling the hook in order to trigger the hook.
